(19) United States
(12) Patent Application Publication
(10) Pub. No.: US 2009/0068335 A1
(43) Pub. Date: Mar. 12, 2009

(54) CRACKER AND METHOD OF MAKING SAME

(76) Inventor: Richard Ogg, Littlestown, PA (US)

Correspondence Address: BERENATO, WHITE & STAVISH, LLC, 6550 ROCK SPRING DRIVE, SUITE 240, BETHESDA, MD, 20817, US

(21) Appl. No.: 12/208,057

(22) Filed: Sep. 10, 2008

Related U.S. Application Data
(60) Provisional application No. 60/935,993, filed on Sep. 10, 2007.

(51) Int. Cl. A21D 2/00; A21D 10/00; A21D 8/00

(52) U.S. Cl. 426/551; 426/549

(57) ABSTRACT

A homogenously mixed dough composition for the preparation of baked crackers comprises a primary seafood flavoring ingredient, a secondary butter flavoring ingredient, and optionally a tertiary flavoring ingredient. A method of manufacturing an edible cracker product is also disclosed.

### CROSS REFERENCE TO RELATED APPLICATION AND CLAIM TO PRIORITY

This application is based on provisional application Ser. No. 60/935,993, filed Sep. 10, 2007, for Richard Ogg, the disclosure of which is incorporated herein by reference and to which priority is claimed under 35 U.S.C. §119(e).

### FIELD OF THE INVENTION

The present invention is directed to a crab or seafood flavored cracker, and a method of making same.

### BACKGROUND OF THE INVENTION

Snack foods play an important part in food culture in the home and on the go, as well as in taverns and restaurants. Snack foods are typically produced to be durable, accessible, inexpensive, and easy to eat out of a bag or package without further preparation. For example, potato chips, tortilla chips, pretzels and glazed nuts are well known snack foods.

Particularly appealing to many people is the consumption of seafood and seafood flavored food items. Long standing regional habits have made use of crab meat and flavors popular, e.g. Blue crabs in Maryland, She crabs in the Carolinas, and Dungeness crabs on the west coast. The crab cake has become a restaurant staple in many areas. In Maryland, Blue crabs are often steamed or boiled and spiced in the process by using a seafood seasoning combination of spices, such as OLD BAY® seasoning. While the flavor and experience of crabs is enjoyed by many, they are difficult to prepare, expensive to purchase and messy to eat. As mentioned above, the crab cake, which consists of crab meat picked from the crab, is seasoned and served after flying, baking or broiling as a cake or patty. The crab cake eliminates much of the mess associated with eating crabs. However, crab cakes are not durable and/or portable. Thus, crab cakes are typically enjoyed as a meal, as opposed to a snack food.

Processed snack foods are typically designed to be less perishable, more durable, and/or more appealing than prepared foods. They often contain substantial amounts of sweeteners, preservatives, and appealing ingredients such as chocolate, peanuts, or specifically designed flavors. For example, potato chips may be flavored with barbeque, salt and vinegar, or onion flavor.

OLD BAY® seasoning is viewed by many as an integral part of Maryland Blue crabs. The popular seasoning is applied to the crabs during the steaming process. In an attempt to capture this flavor, OLD BAY® seasoning has been applied to some snack foods such as potato chips. Although the OLD BAY® seasoning flavor is captured, the primary flavor of crab meat is not.

### SUMMARY OF THE INVENTION

The present invention is directed to a snack food, preferably a cracker, which captures the Maryland Blue crab eating experience. The cracker is less perishable and portable, and particularly well suited for venues such as taverns and restaurants, sporting events, and the like. The disclosed cracker expresses a primary crab flavor of steamed crab meat, similar to the taste sensation derived from the hard shell crab experience. A secondary butter flavor may also be provided. The cracker also includes a tertiary seasoning flavor, preferably that of OLD BAY® seasoning. Preferably, the primary, secondary and tertiary flavors are included and integrally mixed in the dough prior to baking, so that the resulting cracker need not rely on additional additives after baking to create the flavor experience.

A dough composition for the preparation of baked crackers according to an embodiment of the present invention includes water, flour, a primary seafood flavoring ingredient, and a secondary butter flavoring ingredient. Sufficient amounts of the primary and second flavoring ingredients provide crab and butter taste in crackers baked from the dough composition.

The present invention is also directed to a method of manufacturing an edible cracker product. Sufficient amounts of flour, water, baking powder, salt, a primary seafood flavoring ingredient, and a secondary buttery flavoring ingredient, are mixed to form a homogenously blended pliable dough composition. The dough composition is rolled into a thin substrate having a thickness of less than ¼ inch. Dough pieces are cut from the thin substrate, and then baked in a convection oven a sufficient amount of time to form baked crackers. The crackers are then removed from the oven, and allowed to cool.

### BRIEF DESCRIPTION OF THE DRAWING

FIG. 1 is a perspective view of a cracker according to an embodiment of the present invention.

### DETAILED DESCRIPTION OF THE INVENTION

The present invention is directed to a cracker. In a preferred embodiment, the cracker includes a primary crab flavor, such as the flavor of a crab cake. The crab flavor is preferably delicate and not over bearing. For example, the primary crab flavor may offer the taste of claw meat from a steamed crab, similar to the hard shell crab experience. Although real crab meat may be used in the disclosed cracker for achieving the primary crab flavor, an artificial non-allergenic, preferably nonperishable, flavor ingredient is preferably used, such as available from a company that engages in the activity of producing flavor ingredients for commercial use.

The cracker preferably also includes a secondary butter flavor, which is also preferably an artificial non-allergenic flavor ingredient. Preferably, the slightly buttery secondary flavor does not overpower the primary crab (or seafood) flavor.

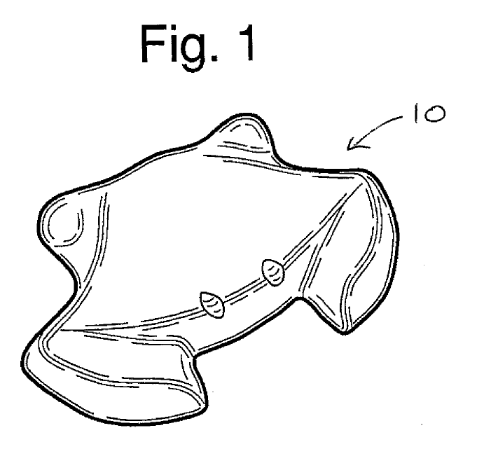

The disclosed cracker may be configured in the shape of a stylized crab 10, as shown in FIG. 1. An exemplary size of the cracker may be approximately one inch square, which I have found optimal for flavor delivery and desirable eating experience. Although the specific shape and size of the cracker may vary, I have found that the configuration of stylized crab 10 provides increased surface area for holding seasoning and therefore enhancing taste. In addition, the configuration of stylized crab 10 is appealing to consumers wishing the Maryland Blue crab experience, and therefore provides commercial advantages. However, one skilled in the art would understand that other configurations are possible, and therefore the present invention is not limited to the configuration of stylized crab 10.

The cracker may comprise either white or wheat flour. Preferably, the texture of the baked white flour cracker prior to application of final seasoning and/or garnish is light, delicate, and white or beige in final color.

Preferably, the cracker also includes a tertiary seasoning flavor. The preferred final seasoning is OLD BAY® seasoning, which may be applied to one or both sides of the cracker. Preferably, a sufficient amount of seasoning is applied to the dough prior to baking, which compliments but does not overpower the primary and secondary flavors. OLD BAY® seasoning also adds red color and spice to the cracker eating experience. Additional salts and/or other spices may also be applied to the dough to adjust flavor, as desired.

An exemplary dough composition for the disclosed cracker is provided:
Crab/seafood flavoring;
1¼ to 1½ cup all-purpose flour;
¾ tsp. baking powder;
Salt;
⅓ cup or more warm water;
2½ tbsp vegetable oil;
Butter flavoring;
Mustard flavoring;
Vinegar flavoring;
Egg lightly beaten;
OLD BAY® seasoning and/or a seafood seasoning blend of species (e.g. a mixture of celery salt, ground rock salt, paprika, black pepper, cayenne pepper, ground dry mustard, mace, cinnamon, ground clover, ginger, and/or nutmeg);
Red and yellow food coloring; and
Water;

Other than the seafood flavor ingredient, other ingredients are exemplary and may be eliminated or substituted with other ingredients depending on the particular dough desired.

In addition, as noted above, real crab or seafood meat may be used for the crab/seafood flavor ingredient, in which case it is preferably pureed until reaching a smooth consistency. For example, real meat from Maryland Blue crabs or other crab species may be used. Alternatively, real meat from other seafood, such as fish, may be used. The crab meat and/or seafood meat may be enhanced with seasoning as desired, and prior to mixing with the cracker dough.

However, preferably the crab/seafood flavor ingredient comprises an artificial crab flavor powder, such as available from a company that engages in the activity of producing flavor ingredients for commercial use. Flavor ingredients designed to mimic the taste of real crab meat are commercially available from such companies.

Similarly, either butter or an artificial butter flavor may be used. Artificial mustard and/or vinegar flavor ingredients may also be used.

A preferred process for bulk manufacturing the disclosed crackers provides for first mixing all of the ingredients together, e.g. flour, crab flavoring, butter flavoring, OLD BAY® seasoning, salt, baking powder, oil (or palm shortening), water, food coloring, mustard flavoring, vinegar flavoring, to form a cracker dough.

All ingredients are thoroughly blended to form homogenously mixed dough. Sufficient water is added during the mixing process to achieve a desired viscosity of the dough, such that the dough is not overly dry. The resulting dough should stay together in a ball, and may therefore be wrapped in plastic wrap and refrigerated.

Preferably on waxed paper or a floured surface, the dough is rolled to form a sheet having a thickness of preferably about ⅛ inch. Using a die cut, such as a cookie-cutter type device, the sheet of dough is cut into pieces, such as having a stylized crab shape 10 as shown in FIG. 1, and placed on a cookie sheet for baking. While the die used to cut the dough into the desired shape may be a hand die cut, alternatively the dough may be cut into the desired shapes using an automated machine, such as with conventional cutter devices known in the art.

The cookie sheet is preferably sprayed with a non-stick butter or oil spray prior to placing the dough thereon. Uncut dough may be re-rolled and cut, although I have found that excessive use of extra dough may result in relatively tough crackers.

Each cut dough piece may then be sprayed with a commercially available butter spray, and placed in a convection oven at 350° F. After approximately 5-7 minutes, the tray may be removed from the oven for application of additional coloring, glazed with beaten egg, and/or seasoning, and then returned to the oven to finishing baking until the crackers are dry and lightly brown, e.g. an additional 10-12 minutes.

However, as noted above, the crab/seafood flavor and seasonings are preferably added to the dough prior to baking. As such, the crackers may be baked in a one-step process, given all desired ingredients, including seasoning and optional colorings, are included in the dough prior to baking. The uncooked dough pieces may be placed in the convection oven and remain therein until the baking process is complete, e.g. about 15-20 minutes.

Once the baking process is complete, the crackers are removed from the oven and allowed to cool, such as on a cooling rack. Optionally, a light coating of additional seasoning may be applied to the crackers after removal from the oven. The cooled crackers may then be placed in a storage container, or immediately packaged, such as in sealed bags.

It will be apparent to one of ordinary skill in the art that various modifications and variations can be made in the composition or configuration of the disclosed cracker without departing from the scope or spirit of the invention. Thus, it is intended that the present invention cover all such modifications and variations, and as may be applied to the central features set forth above.

I claim:

1. A dough composition for the preparation of baked crackers, comprising water, flour, a primary seafood flavoring ingredient, and a secondary butter flavoring ingredient, wherein sufficient amounts of said primary and second flavoring ingredients provide crab and butter taste in crackers baked from the dough composition.

2. The dough composition of claim 1, further comprising a tertiary flavoring ingredient, said tertiary flavoring ingredient comprising salt, paprika, pepper, dry mustard, mace, and cinnamon.

3. The dough compositing of claim 2, wherein said tertiary flavoring ingredient further comprises at least one of celery salt, cayenne pepper, ground clover, ginger, and nutmeg.

4. The dough composition of claim 1, further comprising a tertiary flavoring ingredient of OLD BAY® seasoning.

5. The dough composition of claim 1, further comprising baking powder and salt.

6. The dough composition of claim 1, further comprising a vinegar flavoring ingredient.

7. The dough compositing of claim 1, wherein said primary seafood flavoring ingredient is an artificial, non-allergenic powdered flavor ingredient mimicking a crab meat taste.

8. The dough composition of claim 1, wherein the flour comprises from about 50% to about 80% by volume of the dough composition, and the water comprises from about 10% to about 20% by volume of the dough composition.

9. The dough composition of claim 1, wherein said primary seafood flavoring ingredient is an artificial, nonperishable powdered flavor ingredient mimicking a crab meat taste.

10. The dough composition of claim 1, wherein said secondary butter flavoring ingredient is an artificial, non-perishable powdered flavor ingredient.

11. A method of manufacturing an edible cracker product, comprising the steps of:
mixing sufficient amounts of flour, water, baking powder, salt, a primary seafood flavoring ingredient, and a secondary buttery flavoring ingredient, and thereby forming a homogenously blended pliable dough composition;
rolling the formed dough composition into a thin substrate having a thickness of less than ¼ inch;
cutting dough pieces from the rolled thin substrate;
baking in a convection oven the dough pieces a sufficient amount of time to form baked crackers; and
removing the baked crackers from the oven.

12. The method of claim 11, wherein a tertiary flavoring ingredient of OLD BAY® seasoning is added to the dough composition during said mixing step.

13. The method of claim 11, wherein the convection oven is maintained at a temperature of about 350° F. during said baking step.

14. The method of claim 11, wherein the crab-shaped dough pieces are formed during said cutting step.

15. The method of claim 11, wherein the seafood flavoring ingredient comprises an artificial, non-allergenic powdered flavoring ingredient mimicking a crab meat taste.

16. The method of claim 11, wherein the seafood flavoring ingredient comprises one of real crab meat and real fish meat.

17. The method of claim 11, wherein the thin substrate has a thickness of about ⅛ inch after said rolling step.
